(19) United States
(12) Patent Application Publication
(10) Pub. No.: US 2021/0001486 A1
(43) Pub. Date: Jan. 7, 2021

(54) METHOD FOR CONTROLLING AN INDUSTRIAL ROBOT

(71) Applicant: VOLVO TRUCK CORPORATION, Goteborg (SE)

(72) Inventors: Amr Salem, Trento (IT); Yiannis Karayiannidis, Stockholm (SE)

(21) Appl. No.: 16/458,424

(22) Filed: Jul. 1, 2019

(51) Int. Cl. B25J 9/16

(52) U.S. Cl. CPC B25J 9/1687; B25J 9/163; B25J 9/1633; B25J 9/1664

(57) ABSTRACT

The present disclosure relates to a method adapted to control an industrial robot, where the industrial robot is controlled in two phases for assembling a first and a second component. The present disclosure also relates to a corresponding control system and to a computer program product.

### TECHNICAL FIELD

The present disclosure relates to a method adapted to control an industrial robot, where the industrial robot is controlled in two phases for assembling a first and a second component. The present disclosure also relates to a corresponding control system and to a computer program product.

### BACKGROUND

Industrial robots have found a variety of uses in manufacturing automation. However, an important application domain for robotic automation that has been slightly behind expectations is mechanical assembly. There are various advantages that a robotic assembly has over human assembly since manual labor is boring, fatiguing, and can cause repetitive-motion stress injuries and injuries resulting from the manipulation by the worker of heavy objects during assembly. These effects on humans lead to problems with maintaining quality, efficiency, job satisfaction and health. In those applications where a robot could perform the job, these considerations can make automation highly attractive.

In carrying out assembly using such a robot, it is required to position a first component fixed in place (e.g. on a table) while at the same time moving a second component accurately to the place with the robot. However, between the second component held by the robot and the first component being fixed to the table, there exists a position error and an orientation error, which sometimes adversely affects assembly, or especially, the fitting of the two components by the robot. Accordingly, a good absolute position before assembly may be helpful in reducing the search range during assembly since position control is used to get to a starting point for the assembly. A vision system which gives relative position before the parts to be mated come into contact can help reduce an aimless search.

General robot control schemes for performing an assembly where the first component comprises a hole portion and the second component comprises a peg portion matching the hole portion are well documented. An example of such a scheme is disclosed in U.S. Pat. No. 6,141,863. Specifically, U.S. Pat. No. 6,141,863 relies on control means includes a fitting action performing means for making the component held by the robot hand approach the fixed component and performing a fitting action under force control based on an output from a force sensor. U.S. Pat. No. 6,141,863 further makes use of a correcting means for obtaining component position/orientation data representing the relative position/orientation between the component held by the robot hand and the fixed component based on image data obtained by the visual sensor, for correcting position and orientation of the robot based on the obtained component position/orientation data, in advance of the fitting action.

The solution in U.S. Pat. No. 6,141,863 presents an interesting approach in case the fixed component comprises a concave portion for receiving convex portion comprised with the component held by the robot hand, sometimes referred to as a “Peg-in-the-hole” robot assembly. However, the scheme suggested in U.S. Pat. No. 6,141,863 would not be suitable for the inverse situation, sometimes referred to as a “Hole-on-a-peg” robot assembly, where for example a nut is held by the robot hand and is to be assembled with a bolt (both provided with corresponding threaded portions). Accordingly, there appears to be room for further improvements in regards to the scheme to be used for control of a robot, specifically targeted towards Hole-on-a-peg robot assembly.

### SUMMARY

According to an aspect of the present disclosure, the above is at least partly alleviated by a computer implemented method adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, wherein the method comprises controlling, at an adjustment phase, the position of the second component to contact the first hole portion with the peg portion of the first component, and adjusting, at an alignment phase, an alignment angle of the hole portion of the second component to allow the hole portion of the second component to be inserted onto the peg portion of the first component, wherein a transition from the adjustment phase to the alignment phase only takes place if a three-point contact between the hole portion of the second component and the peg portion of the first component is identified.

The present disclosure is generally based upon the realization that the prior-art approach relating to the Peg-in-the-hole robot assembly is not directly useful in relation to the inverse Hole-on-a-peg robot assembly. Rather, in line with the present disclosure it is suggested to take a completely different approach where the assembly process is separated into two separate phases, where the first phase is a strict adjustment of how the component held by the robot hand (being the second component and comprising a hole portion) is orientated in relation to the other component (being the first component and comprising the peg portion). Only once a specific contact condition is identified between the first and the second component (i.e. the above defined three-point contact), a transition is allowed to take place for aligning the second component in relation to the first component, such that the second component may be inserted onto the first component.

In accordance to the present disclosure, the three-point contact is defined as a situation where the hole portion of the second component is identified to have three separate contacts with the peg portion of the first component. Generally, this state is achieved by performing a stepwise transition from a one-point contact, to a two-point contact and then finally to a three-point contact.

Accordingly, in line with the present disclosure an orientation of the second component is controlled such that the hole portion of the second component forms an initial contact with the peg portion of the first component, including measuring a first contact pressure between the hole and the peg, and adjusting the position of the hole based on the contact pressure. Following achieving the first contact between the hole and the peg, the process proceeds by measuring a second contact pressure between the hole and the peg.

The three-point contact then typically occurs when the alignment angle is large, such as for example when the hole portion of the second component is largely tilted (typically above 6 degrees) as compared to a vertically arranged peg portion of the first component. The three-point contact represents the most stable contact state, since it has the maximum number of geometric constrains. Moreover, by fixing the tilt angle, the configuration of a three-point contact is unique.

As understood from the above, once the three-point contact has been achieved the alignment angle is in comparison relatively large and as such it will typically not be possible to “slide” the hole onto the peg, at least in case of relatively matching diameters. Accordingly, to be able to fully insert the hole onto the peg the alignment angle for the hole portion of the second component, the alignment angle for the hole portion of the second component is adjusted, specifically reduced, such that the hole portion of the second component essentially aligns with the (in this conceptual example) vertically arranged peg portion of the first component.

In some embodiments the control scheme may be further extended to the situation where the hole of the second component comprises a fastener with threaded hole and the peg of the first component comprises a threaded fastener with an external male thread. In such a situation, the scheme may be further adapted to allow the robot to rotate the second component once an alignment between the hole portion of the second component and the peg portion of the first component has been established. Accordingly, in this situation the threaded hole and the external male thread of the fastener will engage such that the fastener with treaded hole may be rotated onto the threaded fastener with an external male thread.

The above discussed control scheme may be used in numerous fields for Hole-on-a-peg robot assembly. For example, the present control scheme may be used in the automotive industry, such as in relation to mounting an oil filter to a vehicle, working machine or similar. Accordingly, one embodiment of the present disclosure the second component is an oil filter.

It should furthermore be understood that the present control scheme may be used in situations where the first component is arranged such that the peg portion is not necessarily arranged in a vertical manner. That is, in line with the present disclosure it may be possible to allow the insertion of the hole portion of the second component onto the peg portion of the first component in a gravity independent manner. Such a situation may for example exist when the second component is an oil filter to be mounted at the mentioned vehicle.

According to another aspect of the present disclosure there is provided a control system arranged adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, the control system comprising a control unit, wherein the control unit is adapted to control, at an adjustment phase, the position of the second component to contact the first hole portion with the peg portion of the first component, and adjust, at an alignment phase, an alignment angle of the hole portion of the second component to allow the hole portion of the second component to be inserted onto the peg portion of the first component, wherein a transition from the adjustment phase to the alignment phase only takes place if a three-point contact between the hole portion of the second component and the peg portion of the first component is identified. This aspect of the present disclosure provides similar advantages as discussed above in relation to the previous aspect of the present disclosure.

The control system may in line with the present disclosure be provided as a component of an industrial robot arrangement, further comprising an industrial robot. The industrial robot may in some embodiments be a velocity-controlled robot.

According to a further aspect of the present disclosure there is provided a computer program product comprising a non-transitory computer readable medium having stored thereon computer program means for operating a control system arranged adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, the control system comprising a control unit, wherein the computer program product comprises code for controlling, by the control unit at an adjustment phase, the position of the second component to contact the first hole portion with the peg portion of the first component, and code for adjusting, by the control unit at an alignment phase, an alignment angle of the hole portion of the second component to allow the hole portion of the second component to be inserted onto the peg portion of the first component, wherein a transition from the adjustment phase to the alignment phase only takes place if a three-point contact between the hole portion of the second component and the peg portion of the first component is identified. Also this aspect of the present disclosure provides similar advantages as discussed above in relation to the previous aspects of the present disclosure.

The computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

Further advantages and advantageous features of the present disclosure are disclosed in the following description and in the dependent claims.

### BRIEF DESCRIPTION OF THE DRAWINGS

With reference to the appended drawings, below follows a more detailed description of embodiments of the present disclosure cited as examples.

In the drawings:

FIG. 1 conceptually illustrates an industrial robot adapted for performing an assembly process in line with the present disclosure;

FIGS. 2A-2F illustrates exemplary steps of arranging a second component comprising a hole portion for insertion onto a corresponding peg portion of a first component, using the industrial robot as shown in FIG. 1;

FIG. 3 show the industrial robot of FIG. 1 performing an assembly process for mounting a spin-on oil filter to an internal combustion engine (ICE) of a vehicle; and

FIG. 4 illustrates the processing steps for performing the method according to the present disclosure.

### DETAILED DESCRIPTION

The present disclosure will now be described more fully hereinafter with reference to the accompanying drawings, in which currently preferred embodiments of the present disclosure are shown. This disclosure may, however, be embodied in many different forms and should not be construed as limited to the embodiments set forth herein; rather, these embodiments are provided for thoroughness and completeness, and fully convey the scope of the disclosure to the skilled addressee. Like reference characters refer to like elements throughout.

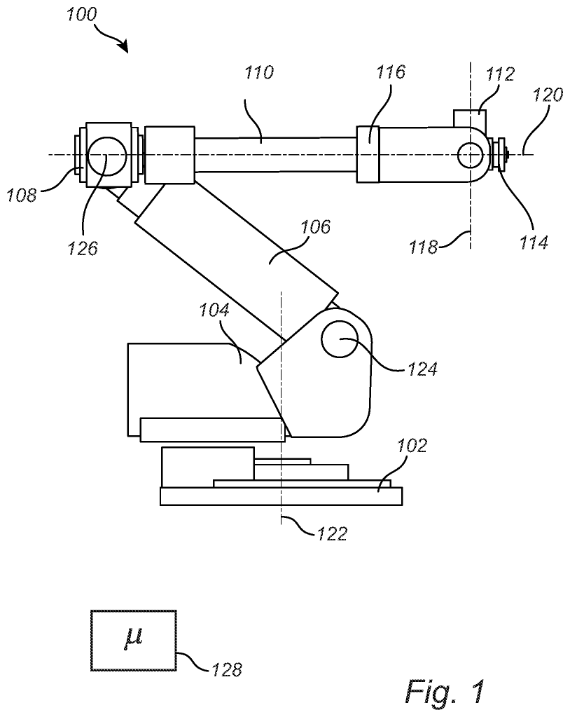

Referring now to the drawings and to FIG. 1 in particular, there is depicted an exemplary illustration of an industrial robot 100 where the control scheme in accordance to the present 35 disclosure may be applied. The exemplified industrial robot 100 is in FIG. 1 shown as a six-axis industrial robot and includes a fixed base 102, a bracket 104 pivotally connected to the fixed base 102, a lower arm 106 pivotally connected to the bracket 104, a joint 108 pivotally connected to the lower arm 106, and a first arm 110, second arm 112 and third arm 114 connected in sequence.

The first arm 110 is rotatably connected to the joint 108 about a first rotation axis 116. The second arm 112 is rotatably connected to the first arm 110 about a second rotation axis 118. The third arm 114 is rotatably connected to the second arm 112 about a third rotation axis 120. In the embodiment shown in FIG. 1, the first and third rotation axes 116, 120 are substantially perpendicular to the second rotation axis 118. The fixed base 102, the lower arm 106 and the joint 108 are rotatable about rotation axes 122, 124, 126, respectively. An actuator, such as a manipulator end-effector or a clamping tool for holding a component to be assembled may be mounted on the distal end of the third arm 114 to perform such an assembly action.

Furthermore, e.g. a vision system comprising a camera (not shown) may for example be arranged in a vicinity of the mentioned manipulator end-effector for acquiring images in relation to the position of the manipulator end-effector in relation to the component held by the clamping tool and intended to be assembled with a further component arranged in a fixed position.

In order to move the industrial robot 100 or any of the robot arms or joints, etc., the robot 100 comprises drives, particularly electrical drives or motors (not explicitly shown), connected to a control system comprising a control unit 128, in a conventional manner. The control unit 128 is in line with the present disclosure loaded with a computer program implementing the control scheme in accordance to the present disclosure. As necessary, the control unit 128 regulates the drives/motors in a manner known to the person skilled in the art. As necessary, the electrical drives are regulated drives, and the control unit 128 generates target signals for the regulated drives.

For reference, the control unit 128 may for example be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

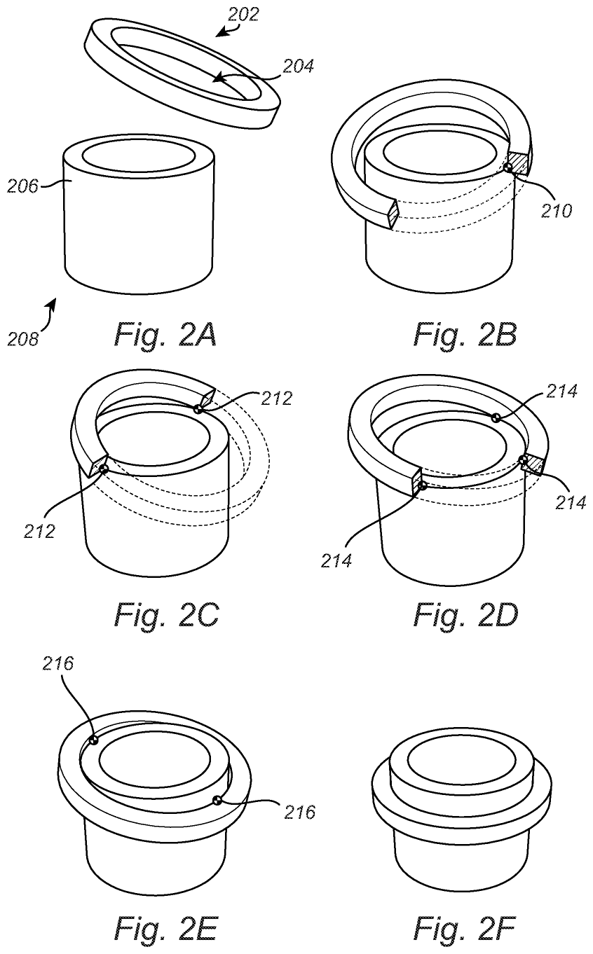

Turning now to FIGS. 2A-2F illustrates exemplary steps of the above discussed Hole-on-a-peg robot assembly, specifically for arranging a second component 202 comprising a hole portion 204 for insertion onto a corresponding peg portion 206 of a first component 208. In line with the illustration as shown in FIG. 1, the steps are automatically performed by the industrial robot 100 using the control scheme according to the present disclosure, under the control of the control unit 128.

The first phase of mounting the hole portion 204 to the peg portion 206 is defined as an adjustment phase. The first step of the adjustment phase is the approach, as is indicated in FIG. 2A, which consists in guiding the second component 202 comprising the hole portion 204, where the second component is mounted on the manipulator end-effector, to a proximity of the peg portion 206 of the first component 208 with a fixed tilt angle with respect to the peg axis. In this step, rough information about the peg position and orientation are provided. This information may be given directly if the position and the orientation of the peg are known from the process or indirectly by estimating it with the mentioned vision system.

Nevertheless, once a rough position and orientation information for the peg portion 206 is given, the hole portion 204 is guided by a position control in proximity of the peg portion 206 with a certain small fixed tilt angle with respect to the peg axis. Afterwards, the hole portion 204 is moved by applying a force parallel to a z-axis of the peg portion 206 until a one-point contact 210 with the peg portion 206 occurs, as indicated in FIG. 2B. This latter force is provided by a velocity/force control. In this case a specific force may be applied along the peg axis, while the other directions are kept rigid.

Once the one-point contact 210 as shown in FIG. 2B has occurred, the process continues into a subsequent step. This step consists in estimating the direction along which the hole portion 204 shall move until an external two-point contact 212 occurs, as shown in FIG. 2C, which is defined as an adjustment direction, and consequently guiding the hole portion 204 along this direction with a controlled velocity/force. The estimation of the adjustment direction is achieved by measuring an external moment with respect to the hole portion 204, while applying a force aligned with the z-axis peg portion 204 as in the initial phase. The latter force guarantees the generation of a moment, which can be used to define uniquely the adjustment direction.

Once the external two-point contact 212 as indicated in FIG. 2C has been detected, the process continues by estimating the direction along which the hole portion 204 shall move until a three-point contact 214 occurs, as indicated in FIG. 2D, and consequently moving the hole portion 204 along this direction with a controlled velocity/force. The new adjustment direction estimation is based on the force measurements, while a parallel force with respect to the z-axis of the peg portion 206 is applied. This latter force generates an expected moment, such that a valid adjustment direction can be estimated.

Following the identified three-point contact 214, the process is only then and in line with the present disclosure transitioned to a subsequent alignment phase. This phase consists in aligning the hole with the peg, i.e. the misalignment between the hole axis and the peg axis is reduced, and consequently the contact state switches from a three-point contact to an internal two-point contact. Specifically, the alignment phase is based on applying a force with direction and a moment around y-axis in a task frame, which is considered the same as the previously defined task frame, such that a solution to switch the contact state from a three-point contact to an internal two-point contact 216 is formed, as indicated in FIG. 2D.

Once the internal two-point contact 216 exists, the process may transition to the final phase of the Hole-on-a-peg robot assembly, the insertion phase. The insertion phase, as indicated in FIG. 2F, consists in inserting the hole portion 204 with a certain depth length into the peg portion 206. In this phase the hole portion 204 is “pushed” while rotating around its axis, and consequently inserted into the peg portion 206 until a certain depth is achieved. In the beginning of this phase, the internal two-point contact 216 is supposed to exist.

The rotation around the z-axis of the hole portion 204 is applied to ease the insertion, since the friction is reduced, and the position uncertainties are distributed. In addition, the hole portion 204 may have a compliant behavior around and along x-axis and y-axis in order to allow small correction in the position and the orientation of the hole during the insertion.

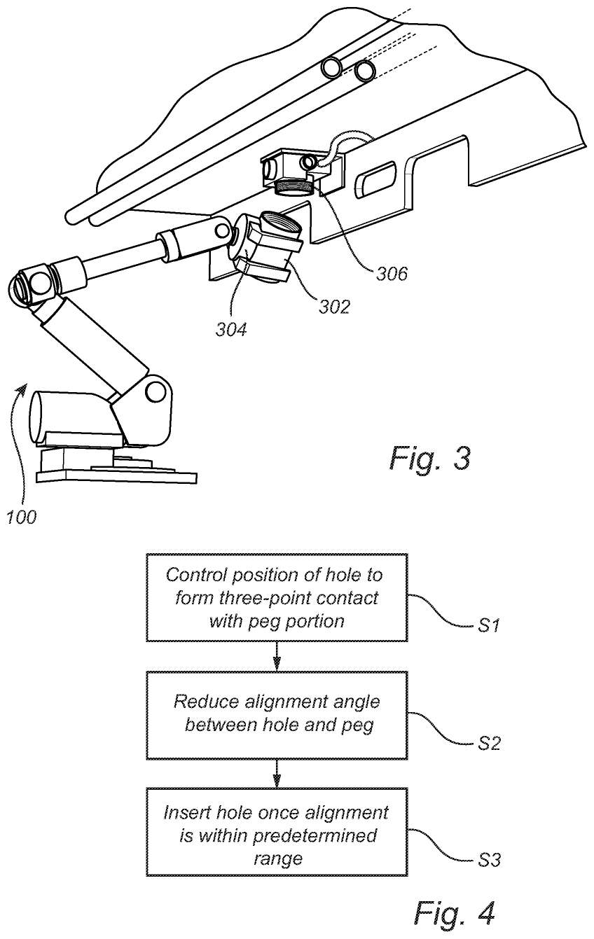

Turning briefly to FIG. 3 which conceptually illustrates a portion of the industrial robot 100 of FIG. 1 performing a Hole-on-a-peg robot assembly, specifically for mounting a spin-on oil filter 302 to an internal combustion engine (ICE) of the vehicle 100. In FIG. 3 a manipulator end-effector 304 of the industrial robot 100 as mentioned above is illustrated as gripping the spin-on oil filter 302. FIG. 3 further shows a threaded mount 306 adapted to match corresponding threads provided at a hole portion (not explicitly shown) of the spin-on oil filter 302.

The assembly process in FIG. 3 greatly resembles the assembly process as exemplified in FIGS. 2A-2F, and may be adapted based on vision data captured using the mentioned vision system. The industrial robot may be so called collaborative robot, coexisting with human workers in e.g. a vehicle assembly plant or in a workshop for servicing the vehicle 100.

In summary and with further reference to FIG. 4, the present disclosure relates to a computer implemented method adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, wherein the method comprises controlling, S1, at an adjustment phase, the position of the second component to contact the first hole portion with the peg portion of the first component, and adjusting, S2, at an alignment phase, an alignment angle of the hole portion of the second component to allow the hole portion of the second component to be inserted, S3, onto the peg portion of the first component, wherein a transition from the adjustment phase to the alignment phase only takes place if a three-point contact between the hole portion of the second component and the peg portion of the first component is identified.

The present disclosure is generally based upon the realization that the prior-art approach relating to the Peg-in-the-hole robot assembly is not directly useful in relation to the inverse Hole-on-a-peg robot assembly. Rather, in line with the present disclosure it is suggested to separate the Hole-on-a-peg robot assembly into two separate steps, where the first step is a strict adjustment of how the component held by the robot hand (being the second component and comprising a hole portion) is orientated in relation to the other component (being the first component and comprising the peg portion).

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Additionally, even though the disclosure has been described with reference to specific exemplifying embodiments thereof, many different alterations, modifications and the like will become apparent for those skilled in the art.

Variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. A computer implemented method adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, wherein the method comprises:
controlling, at an adjustment phase, the position of the second component to contact the first hole portion with the peg portion of the first component, and
adjusting, at an alignment phase, an alignment angle of the hole portion of the second component to allow the hole portion of the second component to be inserted onto the peg portion of the first component,
wherein a transition from the adjustment phase to the alignment phase only takes place if a three-point contact between the hole portion of the second component and the peg portion of the first component is identified.

2. The method according to claim 1, wherein the adjustment phase comprises:
controlling the orientation of the second component such that the hole portion of the second component forms an initial contact with the peg portion of the first component,
measuring a first contact pressure between the hole and the peg, and
adjusting the position of the hole based on the contact pressure.

3. The method according to claim 1, wherein the three-point contact is identified by measuring a second contact pressure between the hole and the peg.

4. The method according to claim 1, wherein the alignment phase comprises monitoring the alignment angle for the hole portion of the second component.

5. The method according to claim 1, wherein the hole of the second component comprises a fastener with treaded hole and the peg of the first component comprises a threaded fastener with an external male thread.

6. The method according to claim 5, further comprising:
rotating the second component once an alignment between the hole portion of the second component and the peg portion of the first component has been established.

7. The method according to claim 1, wherein the second component is an oil filter.

8. The method according to claim 1, wherein inserting the hole portion of the second component onto the peg portion of the first component is arranged to be gravity independent.

9. A control system arranged adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, the control system comprising a control unit, wherein the control unit is adapted to:
control, at an adjustment phase, the position of the second component to contact the first hole portion with the peg portion of the first component, and
adjust, at an alignment phase, an alignment angle of the hole portion of the second component to allow the hole portion of the second component to be inserted onto the peg portion of the first component,
wherein a transition from the adjustment phase to the alignment phase only takes place if a three-point contact between the hole portion of the second component and the peg portion of the first component is identified.

10. The control system according to claim 9, wherein during the adjustment phase the control unit is further adapted to:
control the orientation of the second component such that the hole portion of the second component forms an initial contact with the peg portion of the first component,
measure a first contact pressure between the hole and the peg, and
adjust the position of the hole based on the contact pressure.

11. The control system according to claim 9, wherein the control unit is further adapted to identify the three-point contact by measuring a second contact pressure between the hole and the peg.

12. The control system according to claim 9, wherein during the alignment phase the control unit is further adapted to monitor the alignment angle for the hole portion of the second component.

13. The control system according to claim 9, wherein the hole of the second component comprises a fastener with treaded hole and the peg of the first component comprises a threaded fastener with an external male thread.

14. The control system according to claim 9, wherein the peg of the first component comprises a threaded fastener with an external male thread.

15. The control system according to claim 9, wherein the hole of the second component is an oil filter.

16. The control system according to claim 9, wherein the control unit is adapted to allow inserting the hole portion of the second component onto the peg portion of the first component to be gravity independent.

17. An industrial robot arrangement, comprising:
an industrial robot, and
a control system according to claim 9.

18. The industrial robot arrangement according to claim 17, wherein the industrial robot is a velocity-controlled robot.

19. A computer program product comprising a non-transitory computer readable medium having stored thereon computer program means for operating a control system arranged adapted to control an industrial robot in an assembly process, the assembly process provided for assembling a first and a second component, the first component comprising a peg portion and the second component comprising a hole portion matching the peg portion, the first component being fixed and an orientation of the second component being adjustably controlled by the industrial robot, the control system comprising a control unit, wherein the computer program product comprises:
code for controlling, by the control unit at an adjustment phase, the position of the second component to contact the first hole portion with the peg portion of the first component, and
code for adjusting, by the control unit at an alignment phase, an alignment angle of the hole portion of the second component to allow the hole portion of the second component to be inserted onto the peg portion of the first component,
wherein a transition from the adjustment phase to the alignment phase only takes place if a three-point contact between the hole portion of the second component and the peg portion of the first component is identified.
